(19) United States
(12) Patent Application Publication
(10) Pub. No.: US 2022/0293290 A1
(43) Pub. Date: Sep. 15, 2022

(54) DEVICE FOR INSTALLING EXTERNAL THERMAL INSULATION ON A NUCLEAR REACTOR VESSEL

(71) Applicants: JOINT STOCK COMPANY "ROSENERGOATOM", Moscow (RU); SCIENCE AND INNOVATIONS - NUCLEAR INDUSTRY SCIENCTIFIC DEVELOPMENT, PRIVATE ENTER, Moscow (RU)

(72) Inventors: TIMUR MARATOVICH GUBAIDULOV, Moscow (RU); IGOR EVGEN'EVICH ZHUK, Moscow (RU); SERGEI VLADIMIROVICH IL'YIN, Moscow (RU); ALEKSANDR VASIL'EVICH KOLUSHOV, Moscow (RU); SVETLANA LEONIDOVNA STANKEVICH, Moscow (RU)

(73) Assignees: JOINT STOCK COMPANY "ROSENERGOATOM", Moscow (RU); SCIENCE AND INNOVATIONS - NUCLEAR INDUSTRY SCIENCTIFIC SCIENCE AND INNOVATIONS - NUCLEAR INDUSTRY, Moscow (RU)

(21) Appl. No.: 17/619,117

(22) PCT Filed: Dec. 31, 2019
(86) PCT No.: PCT/RU2019/001054

§ 371 Date: Dec. 14, 2021

(30) Foreign Application Priority Data
Dec. 3, 2019 (RU) 2019139213

(51) Int. Cl. G21C 11/08

(52) U.S. Cl. CPC G21C 11/08

(57) ABSTRACT

The invention refers to the area of nuclear power engineering, particularly to auxiliary devices for nuclear power plants, namely to the devices for installation of the outer heat insulation of a nuclear reactor vessel, and can be used at nuclear plants for recovery annealing of the VVER reactor vessel welds.

The objective to be achieved with the use of the claimed invention is to provide the possibility for installation and dismantling of heat insulation on the outer surface of the VVER reactor vessel in the confined space of the subpile room and at the increased level of ionizing radiation.

Reduction of the temperature gradient through the thickness of the nuclear reactor vessel by heat insulation of the external reactor vessel surface, assurance of uniform physical properties for the reactor vessel metal and welds and reduction of thermal impacts on the surrounding structures during recovery annealing of the welds and/or base metal of the VVER reactor vessel shall be the technical result of this invention.

The technical result of the invention is ensured by the fact that the device for installation of the outer heat insulation of a nuclear reactor vessel includes a mobile transfer trolley equipped with the mechanism for its movement, a removable bearing rim located on the mobile transfer trolley with the reactor vessel heat insulation attached to it, at least two lifting devices located on the opposite sides of the reactor vessel at the level of its upper section, in this case the removable bearing rim is connected to the lifting devices with the possibility to lift and lower it.

Application of the claimed invention will provide the possibility for installation and dismantling of heat insulation on the outer surface of the VVER reactor vessel in the confined space of the subpile room and at the increased level of ionizing radiation. Heat insulation of the external reactor vessel surface will ensure reduction of the temperature gradient through the thickness of the nuclear reactor vessel, uniformity of the physical properties for its metal and welds as well as reduction of thermal impacts on the surrounding structures during recovery annealing of the welds and/or base metal of the VVER reactor vessel.

The invention refers to the area of nuclear power engineering, particularly to auxiliary devices for nuclear power plants, namely to the devices for installation of the outer heat insulation of a nuclear reactor vessel, and can be used at nuclear plants for recovery annealing of welds and/or base metal of the VVER reactor vessel.

No devices for installation of the outer heat insulation of a nuclear reactor vessel are known from the prior art.

The objective to be achieved with the use of the claimed invention is to provide the possibility for installation and dismantling of heat insulation on the outer surface of the VVER reactor vessel in the confined space of the subpile room and at the increased level of ionizing radiation.

Reduction of the temperature gradient through the thickness of the nuclear reactor vessel by heat insulation of the external reactor vessel surface, assurance of uniform physical properties for the reactor vessel metal and welds and reduction of thermal impacts on the surrounding structures during recovery annealing of the welds and/or base metal of the VVER reactor vessel shall be the technical result of this invention.

The technical result of the invention is ensured by the fact that the device for installation of the outer heat insulation of a nuclear reactor vessel includes a mobile transfer trolley equipped with the mechanism for its movement, a removable bearing rim located on the mobile transfer trolley with the reactor vessel heat insulation attached to it, at least two lifting devices located on the opposite sides of the reactor vessel at the level of its upper section, in this case the removable bearing rim is connected to the lifting devices with the possibility to lift and lower it.

Heat insulation of the nuclear reactor vessel is preferably arranged in the form of rolled heat insulating mats and heat insulating blocks attached to the top edge of the removable bearing rim. The removable bearing rim may be arranged in the form of at least two sectors pivot-hinged to each other with the possibility of folding and unfolding, in this case a modular rail can be attached to the outer surface of the bearing rim, and removable carriages with rolled heat insulating mats suspended to them can be installed on this rail with the possibility of sliding. Heat insulating blocks may be arranged in the form of packages fixed in metal frames and consisting of triangular sheets made of mullite-siliceous cardboard. Siliceous fabric tapes closing the gaps between the adjacent rolled heat insulating mats are preferably arranged along the edges of rolled heat insulating mats. The mobile transfer trolley may be installed on wheel-pairs and contain the racks with their top free ends connected by a beam with two revolving frames equipped with support semi-rings and the mechanism for their folding into the vertical position installed on it with the possibility for rotation by 90°. The removable bearing rim is preferably located on the support semi-rings of the mobile transfer trolley revolving frames. The mobile transfer trolley may contain a lock mechanism, and the lifting devices may contain rope winches with ropes and be equipped with fixing mechanisms.

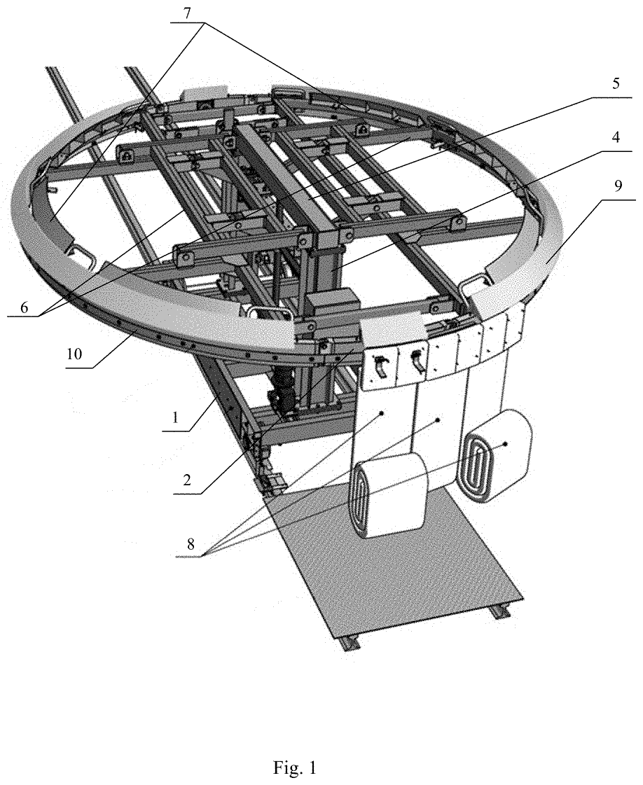

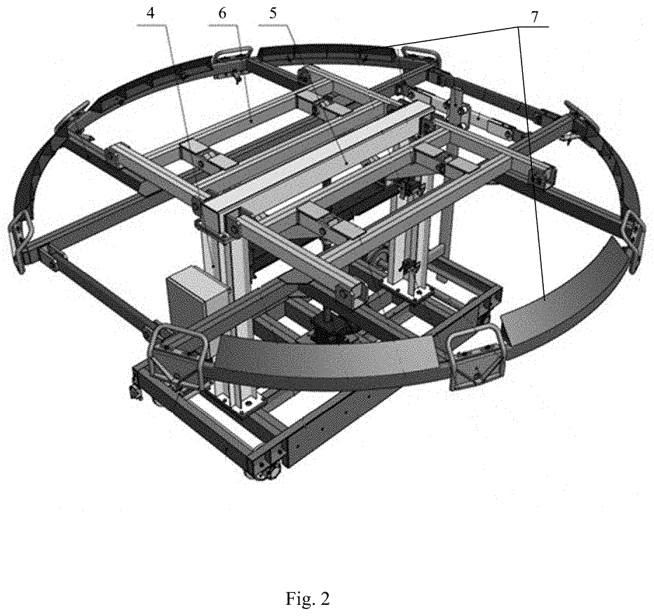

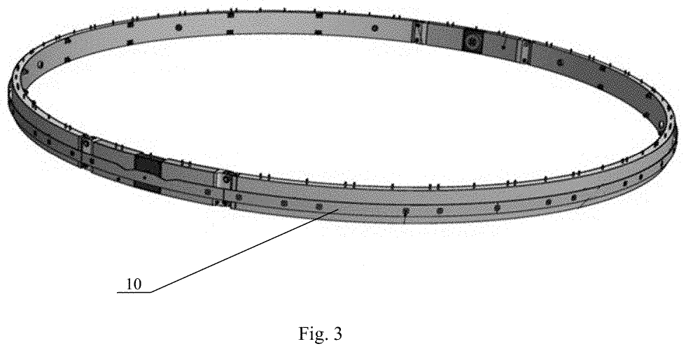

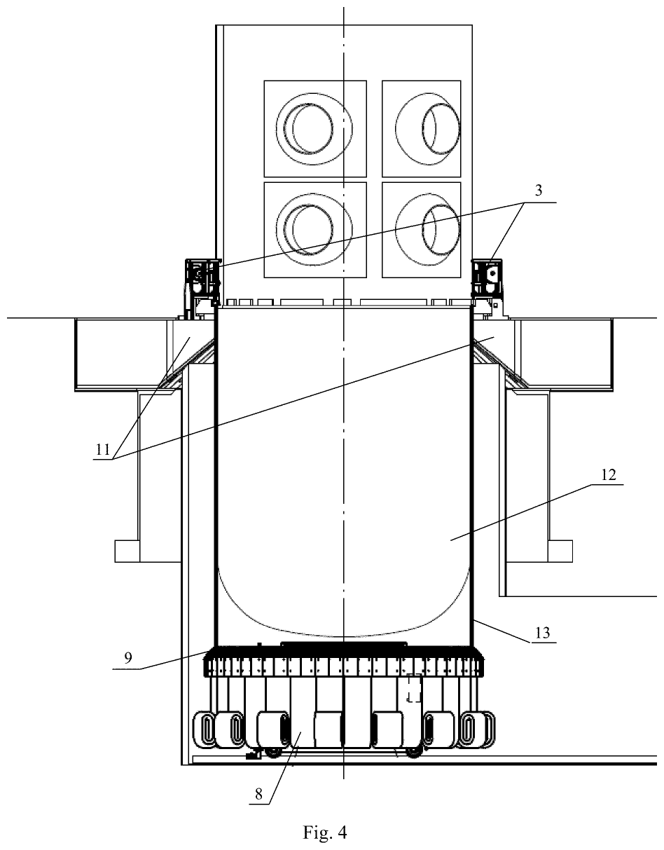

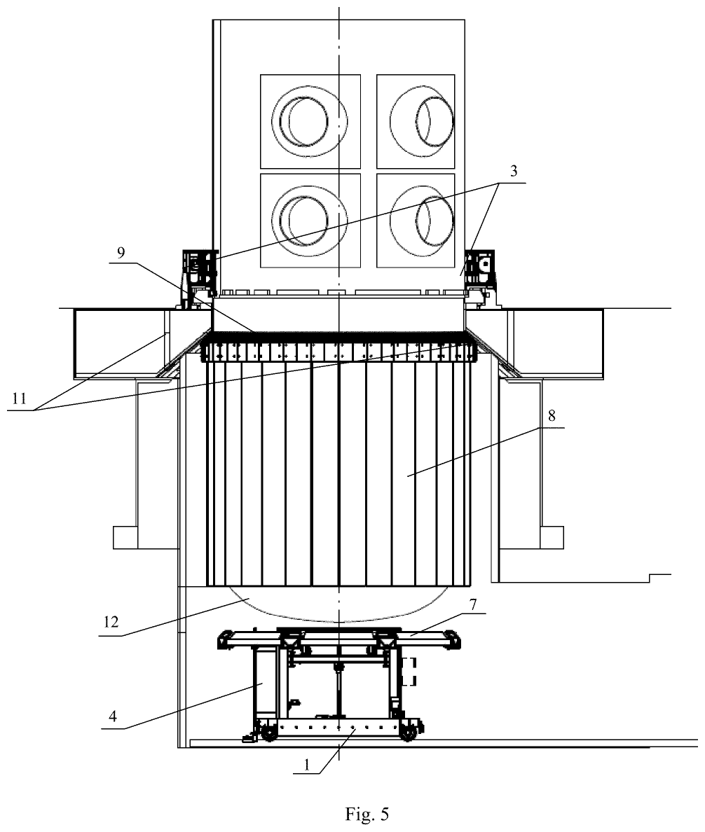

The claimed invention is clarified with graphical materials and presented in one of the options where the general arrangement of the device is given in FIG. 1 (the lifting devices are not shown), the mobile transfer trolley—in FIG. 2, the removable bearing rim—in FIG. 3, the diagram of the device prior to heat insulation installation—in FIG. 4, and the diagram of the device after heat insulation installation—in FIG. 5.

The device for installation of the outer heat insulation of a nuclear reactor vessel consists of the mobile transfer trolley 1, the removable bearing rim 2 and lifting devices 3 (FIGS. 4 and 5). The transfer trolley 1 is installed on the rail track with the use of wheel-pairs, in this case one of them is driving and has a drive. The transfer trolley 1 contains the racks 4 with their top free ends connected by the beam 5 with two revolving frames 6 equipped with support semi-rings 7 and the mechanism for their turning (folding) into the vertical position pivot-hinged on it with the possibility for rotation by 90°. The transfer trolley 1 is equipped with the lock mechanism in order to fix its position on the rail track. The removable bearing rim 2 is installed on the support semi-rings 7 of the mobile transfer trolley 1. Heat insulation is arranged in the form of rolled heat insulating mats 8 and heat insulating blocks 9.

The removable bearing rim 2 is arranged in the form of two sectors (semi-rings) pivot-hinged to each other with the possibility of vertical folding and unfolding into the horizontal position. The modular rail 10 on which the removable carriages with suspended rolled heat insulating mats 8 made of siliceous fabric and intended to arrange a uniform heat insulating layer around the reactor vessel in the operating position of the device are installed with the possibility of sliding is attached to the outer surface of the removable bearing rim 2. In the initial position of the device the heat insulating mats 8 are rolled and fixed in the folded state with the use of loops made of siliceous fabric and metal buttons. The rolled heat insulating mats 8 have tapes made of siliceous fabric along their edges in order to cover the gaps between the adjacent mats 8 in the operating position.

Heat insulating blocks 9 arranged in the form of triangular sheets made of mullite-siliceous cardboard and fixed on metal frames that are intended to ensure a uniform heat insulating layer protecting the cone-shaped section of the supporting truss 11 of the reactor vessel 12 against any thermal impact in the operating position of the device during recovery annealing of the reactor vessel 12 are attached to the top edge of the bearing rim 2 with the use of quick-detachable joints.

The lifting devices 3 consisting of rope winches, fixing mechanisms and ropes with the bottom ends attached to the removable bearing rim 2 in the operating position of the device are attached on the opposite sides of the reactor vessel 12 at the level of its upper section.

The device for installation of the outer heat insulation of a nuclear reactor vessel functions as follows.

The lifting devices 3 are attached on the opposite sides of the reactor vessel 12 at the level of its upper section. The ropes 13 of the lifting device winches are hauled down along the reactor vessel 12.

The removable bearing rim 2 is installed on the support semi-rings 7 of the transfer trolley 1. Heat insulating blocks 9 are attached to the top edge of the removable bearing rim 2 with the use of quick-detachable joints, in this case the heat insulating blocks 9 located above the hinges of the removable bearing rim (4 pcs.) shall not be installed.

The revolving frames 6 with the support semi-rings 7 attached to them and the removable bearing rim 2 sectors (semi-rings) pivot-hinged to each other are brought into the vertical (folded) position with the use of the rotary mechanism and fixed in this position.

The transfer trolley 1 with the bearing rim 2 in the folded position is moved with the use of the drive to the subpile room along the rail track. The transfer trolley 1 with the bearing rim is installed under the reactor vessel 12 centrally. The transfer trolley 1 is fixed on the rail track with the use of the lock mechanism, and then the support semi-rings 7 with the removable bearing rim 2 sectors (semi-rings) are unfolded into the horizontal position with the use of the rotary (folding) mechanism. Stoppers are installed at the hinged joints of the removable bearing rim 2 sectors (semi-rings) in order to prevent their folding. Heat insulating blocks (4 pcs.) are additionally attached to the top edge of the removable bearing rim 2 above its hinged joints.

Rolled heat insulating mats 8 fixed in the folded state with the use of loops made of siliceous fabric and metal buttons are suspended on the modular rail 10 of the removable bearing rim 2 along the entire perimeter with the use of mobile carriages. Subsequent to suspension of the rolled heat insulating mats 8 the metal buttons of the fixing loops are unfastened in order to provide the possibility for free unwinding of the rolled heat insulation.

Then the bottom ends of the ropes 13 are attached to the removable bearing rim 2, and the bearing rim 2 with the heat insulation suspended to it is lifted with the use of the lifting devices 3 till the heat insulating blocks 9 abut against the cone-shaped section of the supporting truss 11 of the reactor vessel 12, and then the lifting devices 3 are locked with the use of the fixing mechanisms.

In order to dismantle the heat insulation upon completion of any recovery annealing operations for the reactor vessel the removable bearing rim 2 is lowered onto the transfer trolley 1 with the use of the lifting devices 3, the ropes 13 are detached from the removable bearing rim 2, and the heat insulation is dismantled. Then the stoppers used to prevent folding are removed from the hinged joints of the removable bearing rim 2 sectors (semi-rings), and the support semi-rings 7 with the bearing rim 2 sectors are folded into the vertical position. Then the transfer trolley 1 with the removable bearing rim 2 is moved from the subpile room to the room for decontamination, maintenance and storage along the rail track.

Application of the claimed invention will provide the possibility for installation and dismantling of heat insulation on the outer surface of the VVER reactor vessel in the confined space of the subpile room and at the increased level of ionizing radiation. Heat insulation of the external reactor vessel surface will ensure reduction of the temperature gradient through the thickness of the nuclear reactor vessel, uniformity of the physical properties for its metal and welds as well as reduction of thermal impacts on the surrounding structures during recovery annealing of the welds and/or base metal of the VVER reactor vessel.

1. A device for installation of the outer heat insulation of a nuclear reactor vessel including a mobile transfer trolley equipped with the mechanism for its movement, a removable bearing rim located on the mobile transfer trolley with the reactor vessel heat insulation attached to it, at least two lifting devices located on the opposite sides of the reactor vessel at the level of its upper section, in this case the removable bearing rim is connected to the lifting devices with the possibility to lift and lower it.

2. A device according to claim 1 characterized in that the reactor vessel heat insulation is arranged in the form of rolled heat insulating mats and heat insulating blocks attached to the top edge of the removable bearing rim.

3. A device according to claim 2 characterized in that the removable bearing rim is arranged in the form of at least two sectors pivot-hinged to each other with the possibility of folding and unfolding, in this case a modular rail is attached to the outer surface of the bearing rim, and removable carriages with rolled heat insulating mats suspended to them are installed on this rail with the possibility of sliding.

4. A device according to claim 2 characterized in that the heat insulating blocks are arranged in the form of packages fixed in metal frames and consisting of triangular sheets made of mullite-siliceous cardboard.

5. A device according to claim 2 characterized in that siliceous fabric tapes closing the gaps between the adjacent rolled heat insulating mats are arranged along the edges of the rolled heat insulating mats.

6. A device according to claim 1 characterized in that the mobile transfer trolley is installed on wheel-pairs and contains the racks with their top free ends connected by a beam with two revolving frames equipped with support semi-rings and the mechanism for their folding installed on it with the possibility for rotation by 90°.

7. A device according to claim 6 characterized in that the removable bearing rim is installed on the support semi-rings of the mobile transfer trolley revolving frames.

8. A device according to claim 1 characterized in that the mobile transfer trolley contains a lock mechanism.

9. A device according to claim 1 characterized in that the lifting devices contain rope winches with ropes and are equipped with fixing mechanisms.
